(19) United States
(12) Patent Application Publication
(10) Pub. No.: US 2002/0074460 A1
(43) Pub. Date: Jun. 20, 2002

(54) Cable management hub apparatus for organizing a physical workspace of a computer system

(76) Inventor: Yves Behar, Oakland, CA (US)

Correspondence Address: JAMES E. EAKIN, McDERMOTT, WILL & EMERY, 3150 PORTER DRIVE, PALO ALTO, CA, 94304-1212, US

(21) Appl. No.: 09/738,037

(22) Filed: Dec. 16, 2000

(51) Int. Cl. F16L 3/00; E21F 17/02

(52) U.S. Cl. 248/51; 248/58; 248/65

(57) ABSTRACT

The present invention provides a cable management hub apparatus for organizing a physical workspace of a computer system. In an exemplary embodiment, the cable management hub apparatus includes the following: a backing; a fabric fixedly attached to the backing; at least four loops fixedly attached to the backing; a hook fixedly attached to the backing; and at least four bend points in the backing and the fabric. In an exemplary embodiment, the cable management hub apparatus includes the following: at least four leaves; and a center portion. In a further embodiment, each leaf includes the following: a loop; a backing attached to the loop; and a fabric attached to the backing. In a further embodiment, the center portion includes the following: a hook; a backing attached to the hook; and a fabric attached to the backing.

### BACKGROUND OF THE INVENTION

The workspace of a computer system typically has some clutter. For example, cables, pens, paper, headphones, and other articles may lay about the workspace.

In addition, computer system distribution companies desire to brand, or to develop loyalty to, their services to users, without designing the computer systems which they distribute.

To date, there are no items which both help to organize the workspace of a computer system while also branding the services of the computer system distribution company which distributed the computer system.

Therefore, a cable management hub apparatus for organizing a physical workspace of a computer system is needed.

### SUMMARY OF THE INVENTION

The present invention provides a cable management hub apparatus for organizing a physical workspace of a computer system. In an exemplary embodiment, the cable management hub apparatus includes the following: a backing; a fabric fixedly attached to the backing; at least four loops fixedly attached to the backing; a hook fixedly attached to the backing; and at least four bend points in the backing and the fabric. In an exemplary embodiment, the cable management hub apparatus includes the following: at least four leaves; and a center portion. In a further embodiment, each leaf includes the following: a loop; a backing attached to the loop; and a fabric attached to the backing. In a further embodiment, the center portion includes the following: a hook; a backing attached to the hook; and a fabric attached to the backing.

### THE FIGURES

FIG. 1A is a top view of a cable management hub apparatus for organizing a physical workspace of a computer system in accordance with an exemplary embodiment of the present invention.

FIG. 1B is a bottom view of the cable management hub apparatus in accordance with an exemplary embodiment of the present invention.

FIG. 1C is a view of the cable management hub apparatus with its leaves with its leaves all bent in accordance with an exemplary embodiment of the present invention.

FIG. 2A shows various configurations of cable management hub apparatus 100 in accordance with an exemplary embodiment of the present invention.

FIG. 2B shows a fully-closed configuration of cable management hub apparatus 100 in accordance with an exemplary embodiment of the present invention.

### DETAILED DESCRIPTION OF THE INVENTION

The present invention provides a cable management hub apparatus for organizing a physical workspace of a computer system.

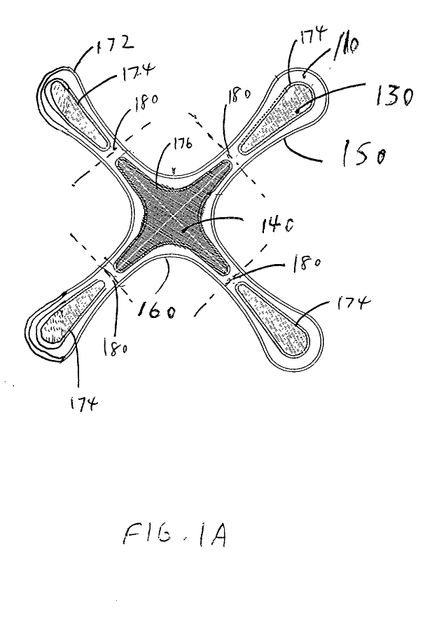

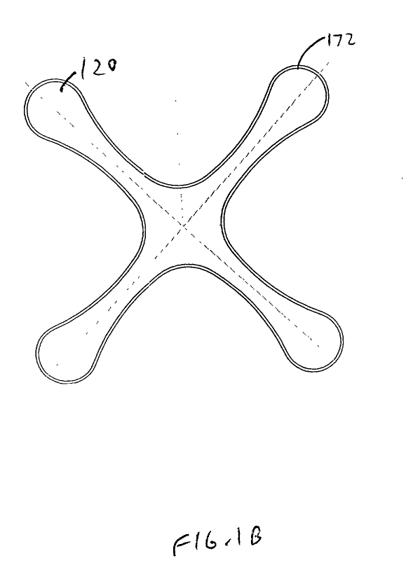

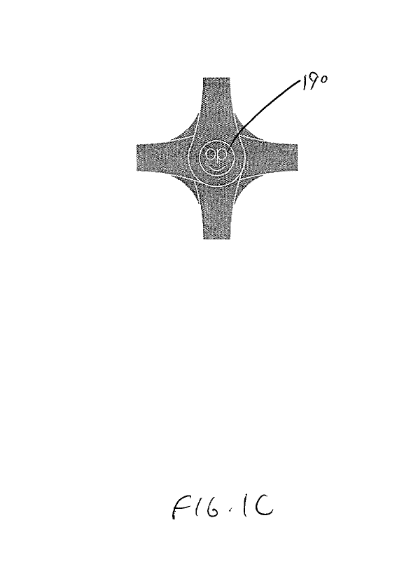

Referring to FIG. 1A, a top view of a cable management hub apparatus 100 for organizing a physical workspace of a computer system in accordance with an exemplary embodiment of the present invention is shown.

Referring to FIG. 1B, a bottom view of cable management hub apparatus 100 for organizing a physical workspace of a computer system in accordance with an exemplary embodiment of the present invention is shown.

Referring to FIGS. 1A and 1B, in an exemplary embodiment, cable management hub apparatus 100 includes (1) a backing 110, (2) a fabric 120, (3) at least four loops 130, (4) a hook 140, and (5) at least four bend points 180.

In an exemplary embodiment, backing 110 is constructed of EVA foam. EVA foam is moldable and lightweight. In an exemplary embodiment, backing 110 is constructed of EVA foam with a durometer value between 2 and 4.

In an exemplary embodiment, fabric 120 is soft, thereby increasing the appeal of cable management hub 100 to a user. In an exemplary embodiment, fabric 120 is a material of attaching to Velcro.

In an exemplary embodiment, each loop 130 is constructed of a first type of Velcro such that each loop 130 can be removably attached to hook 140.

In an exemplary embodiment, hook 140 is constructed of a second type of Velcro such that each loop 130 can be removably attached to hook 140.

In an exemplary embodiment, backing 110 is fixedly attached to fabric 120 by gluing and sewing fabric 120 and backing 110 together. In an exemplary embodiment, fabric 120 and backing 110 are sewn together at sew points 172. In an exemplary embodiment, fabric 120 and backing 110 are glued together throughout their respective, touching, surfaces.

In an exemplary embodiment, each loop 130 is fixedly attached to backing 110 by sewing loop 130 and backing 110 together. In an exemplary embodiment, each loop 130 and backing 110 are sewn together at sew points 174.

In an exemplary embodiment, hook 140 is fixedly attached to backing 110 by sewing hook 140 and backing 110 together. In an exemplary embodiment, hook 140 and backing 110 are sewn together at sew points 176.

In an exemplary embodiment, cable management hub apparatus 100 includes at least four leaves 150 and a center portion 160. In an exemplary embodiment, each leaf 150 includes a loop 130, backing 110, and fabric 120. In an exemplary embodiment, center portion 160 includes hook 140, backing 110, and fabric 120.

In an exemplary embodiment, each leaf 150 can fold onto and attach to center portion 160 (1) by being able to be bent at bend point 180 and (2) by having its loop 130 attach to hook 140.

In an exemplary embodiment, each leaf 150 can fold onto and attach to fabric 120 (1) by being able to be bent at bend point 180 and (2) by having its loop 130 attach to fabric 120.

Referring next to FIG. 1C, a view of cable management hub apparatus 100 with its leaves all bent in accordance with an exemplary embodiment of the present invention is shown. In an exemplary embodiment, cable management hub apparatus 100 is capable of having each leaf 150 bent at bend points 180, with one leaf 150 attached to center portion 160, and with three leaves 150 attached to fabric 120. In an exemplary embodiment, on leaf 130 includes a logo of a company, such as PeoplePC, Inc.

### Exemplary Views

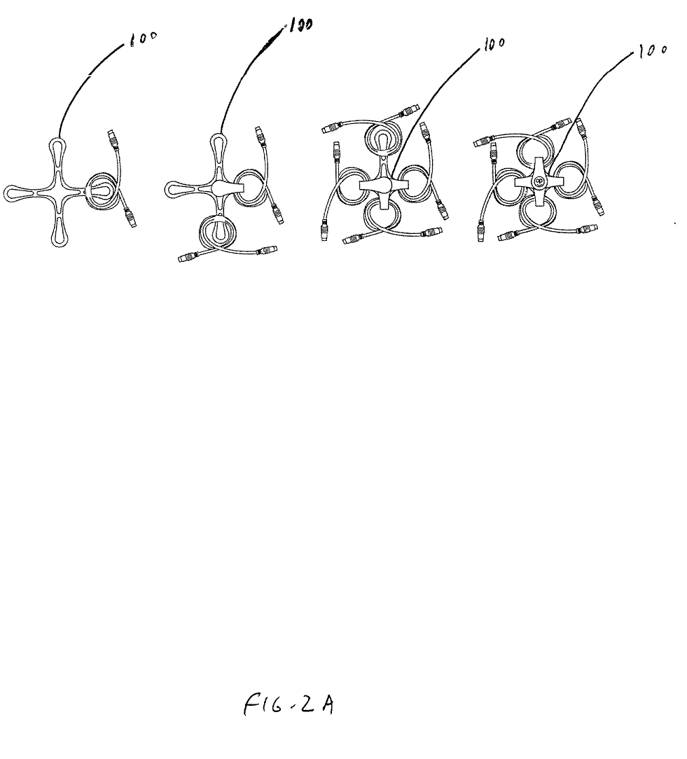

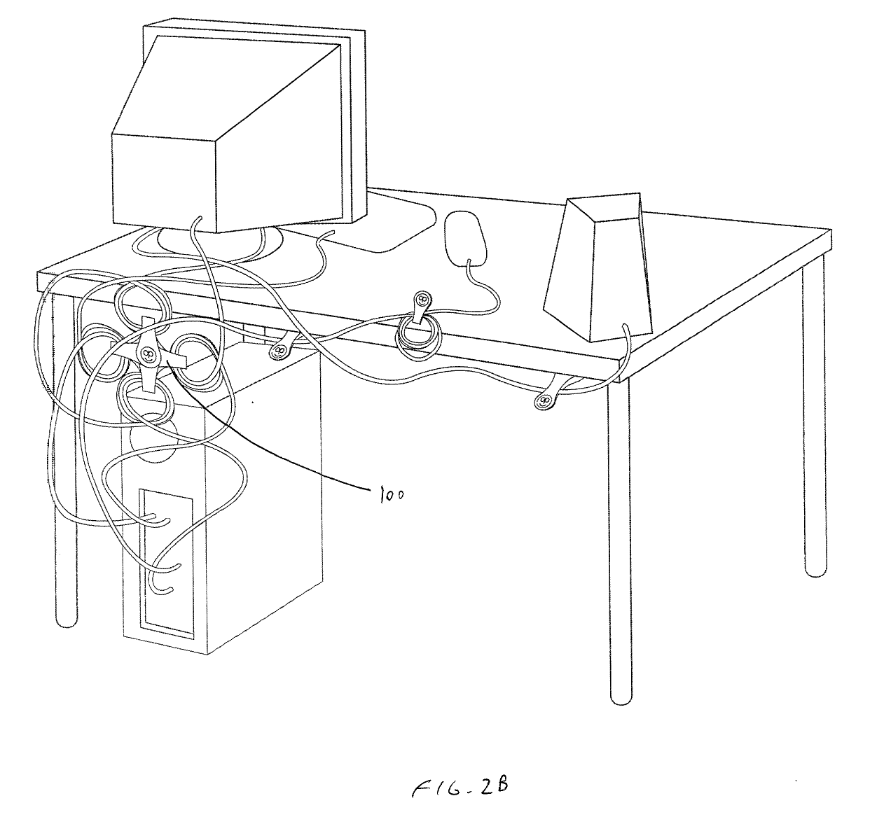

Referring next to FIG. 2A, various configurations of cable management hub apparatus 100 in accordance with an exemplary embodiment of the present invention are shown.

Referring next to FIG. 2B, a fully-closed configuration of cable management hub apparatus 100 in accordance with an exemplary embodiment of the present invention is shown.

### Conclusion

The present invention relates to organizing the physical workspace of a computer system. More particularly, the invention relates to a cable management hub apparatus for organizing a physical workspace of a computer system.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A cable management hub apparatus for organizing a physical workspace of a computer system, comprising:
a backing;
a fabric fixedly attached to the backing;
at least four loops fixedly attached to the backing;
a hook fixedly attached to the backing; and
at least four bend points in the backing and the fabric.

2. The cable management hub apparatus of claim 1 wherein the backing comprises EVA foam.

3. The cable management hub apparatus of claim 1 wherein the fabric comprises a material capable of attaching to Velcro.

4. The cable management hub apparatus of claim 1 wherein each loop comprises a first type of Velcro such that the loop can be removably attached to the hook.

5. The cable management hub apparatus of claim 4 wherein the hook comprises a second type of Velcro such that each loop can be removably attached to the hook.

6. The cable management hub apparatus of claim 1 wherein the backing is fixedly attached to the fabric by gluing and sewing the fabric and the backing together.

7. A cable management hub apparatus for organizing a physical workspace of a computer system, comprising:
at least four leaves; and
a center portion.

8. The cable management hub apparatus of claim 7 wherein each leaf comprises:
a loop;
a backing attached to the loop; and
a fabric attached to the backing.

9. The cable management hub apparatus of claim 7 wherein the center portion comprises:
a hook;
a backing attached to the hook; and
a fabric attached to the backing.
